(19) United States
(12) Patent Application Publication
(10) Pub. No.: US 2008/0005029 A1
(43) Pub. Date: Jan. 3, 2008

(54) IMAGE FORMING APPARATUS, LICENSE MANAGEMENT METHOD, AND LICENSE MANAGEMENT PROGRAM PRODUCT

(76) Inventor: Mitsuo ANDO, Fukuoka (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/758,410

(22) Filed: Jun. 5, 2007

(30) Foreign Application Priority Data
Jun. 7, 2006 (JP) 2006-158704
May 30, 2007 (JP) 2007-143645

(51) Int. Cl. G06Q 10/00; H04L 9/00

(52) U.S. Cl. 705/51; 705/1

(57) ABSTRACT

A disclosed image forming apparatus to which a program can be additionally provided includes an activation determining unit configured to receive, via a communication network, usage permission data that is associated with program identification information unique to each program and device identification information unique to each image forming apparatus. The activation determining unit determines whether a target program is permitted to be activated by respectively comparing the program identification information and the device identification information associated with the usage permission data with program identification information of the target program and device identification information of the image forming apparatus in which the activation determining unit is included.

### BACKGROUND OF THE INVENTION

1. Field of the Invention

The present invention relates generally to image forming apparatuses, license management methods, and license management program products, and more particularly to an image forming apparatus, a license management method, and a license management program product with which an application recorded in a portable recording medium can be executed.

2. Description of the Related Art

In recent years and continuing, multifunction peripherals are commercially available in the market. Such a multifunction peripheral includes functions of a copier, a printer, a scanner, a facsimile machine, etc. When the multifunction peripheral functions as a copier or a printer, it prints out an image on a sheet of paper; when the multifunction peripheral functions as a copier or a scanner, it scans an image from an original; and when the multifunction peripheral functions as a facsimile machine, it transmits/receives an image to/from another device via a telephone line.

In a multifunction peripheral, various kinds of information processing are executed by various programs (computer programs) such as applications and platforms. These programs are typically installed in the multifunction peripheral before shipment. However, it would be convenient to be able to install programs in the multifunction peripheral after shipment. If a program can be installed in a multifunction peripheral by inserting into the multifunction peripheral a memory card storing the program, it would be useful in cases where the manufacturer of the multifunction peripheral permits the vendor of the multifunction peripheral to develop the program.

However, problems would arise if a program is illegally copied or falsified. For example, if a program is illegally copied, a loss in sales profits would be caused; if a program is falsified, the version of the multifunction peripheral would be illegally upgraded, which would cause a loss in profits made by renting the multifunction peripheral. The former problem is a critical issue for the vendor and the latter problem is a critical issue for the manufacturer.

To address these problems, Patent Document 1 discloses a technology for preventing falsification or illegal use of programs distributed with (provided in) memory cards.

Patent Document 1: Japanese Laid-Open Patent Application No. 2005-301968

However, if programs are totally prevented from being copied, it may be inconvenient for users without any intention of illegal use. For example, when such a user desires to use the program with another memory card, the user needs to purchase another memory card storing the same program. Furthermore, if it is ensured that the act of creating copies would not incur a loss in sales profits, it would not be problematic to permit programs to be copied.

### SUMMARY OF THE INVENTION

The present invention provides an image forming apparatus, a license management method, and a license management program product in which one or more of the above-described disadvantages are eliminated.

A preferred embodiment of the present invention provides an image forming apparatus, a license management method, and a license management program product with which licenses for using programs are managed in a flexible manner.

An embodiment of the present invention provides an image forming apparatus to which a program can be additionally provided, the image forming apparatus including an activation determining unit configured to receive, via a communication network, usage permission data that is associated with program identification information unique to each program and device identification information unique to each image forming apparatus, wherein said activation determining unit determines whether a target program is permitted to be activated by respectively comparing the program identification information and the device identification information associated with the usage permission data with program identification information of the target program and device identification information of the image forming apparatus in which the activation determining unit is included.

An embodiment of the present invention provides a license management method executed by an image forming apparatus to which a program can be additionally provided, the license management method including the steps of receiving, via a communication network, usage permission data that is associated with program identification information unique to each program and device identification information unique to each image forming apparatus; and determining whether a target program is permitted to be activated by respectively comparing the program identification information and the device identification information associated with the usage permission data with program identification information of the target program and device identification information of the image forming apparatus executing the license management method.

According to one embodiment of the present invention, an image forming apparatus, a license management method, and a license management program product are provided, with which licenses for using programs are managed in a flexible manner.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a software configuration of a multifunction peripheral according to an embodiment of the present invention;

FIG. 2 is a hardware block diagram of the multifunction peripheral;

FIG. 3 illustrates a multifunction peripheral activating unit;

FIG. 4 illustrates software relevant to an SD memory card slot and an SD memory card;

FIG. 5 illustrates an overview of license management of an application according to an embodiment of the present invention;

FIG. 6 is an example of the structure of information held in an activation key;

FIG. 7 illustrates procedures of applying for and distributing the activation key according to a first embodiment of the present invention;

FIG. 8 illustrates a process of activating an application using the activation key according to the first embodiment of the present invention;

FIG. 9 illustrates procedures of applying for and distributing an activation key according to a second embodiment of the present invention;

FIG. 10 illustrates a process of activating an application using the activation key according to the second embodiment of the present invention;

FIG. 11 illustrates procedures of applying for and distributing an activation key by a node lock license method according to a third embodiment of the present invention;

FIG. 12 illustrates procedures of applying for and distributing an activation key by a floating license method according to the third embodiment of the present invention;

FIG. 13 is a sequence diagram of a process of installing and activating a JSDK platform according to the third embodiment of the present invention;

FIG. 14 is a flowchart of a process of determining whether usage of an application is permitted based on the activation key;

FIG. 15 is a sequence diagram of a process of installing and activating a JSDK application according to the third embodiment of the present invention;

FIG. 16 illustrates a process of activating an application using an activation key associated with a user; and

FIG. 17 is a block diagram of a software configuration of the multifunction peripheral, in which an activation service and an install service are implemented as the JSDK application.

### DETAILED DESCRIPTION OF THE PREFERRED EMBODIMENTS

A description is given, with reference to the accompanying drawings, of an embodiment of the present invention.

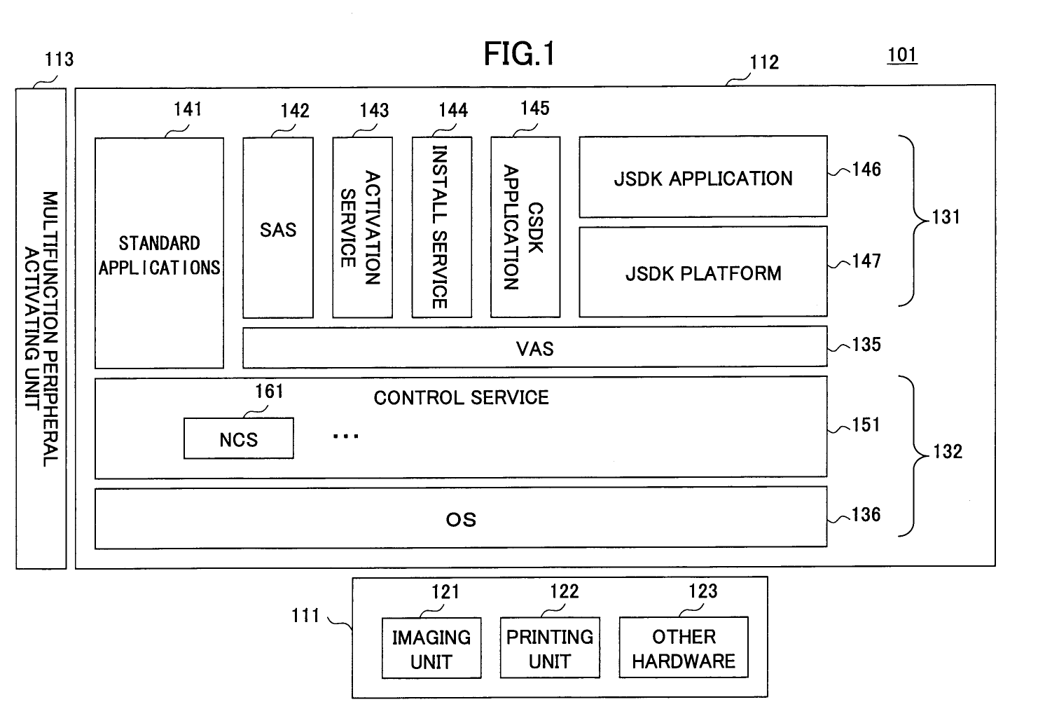

FIG. 1 is a block diagram of a software configuration of a multifunction peripheral 101 according to an embodiment of the present invention. The multifunction peripheral 101 shown in FIG. 1 is an example of an image forming apparatus, and includes various hardware components 111, various software components 112, and a multifunction peripheral activating unit 113.

The multifunction peripheral 101 includes hardware 111 such as an imaging unit 121, a printing unit 122, and other hardware 123. The imaging unit 121 is a hardware component for scanning an image (image data) from an original. The printing unit 122 is a hardware component for printing the image (image data) onto a sheet.

The multifunction peripheral 101 includes software 112 (computer programs) such as various applications 131 and various platforms 132.

The applications 131 include standard applications 141, an SDK application service (SAS) 142, an activation service 143, an install service 144, a CSDK application 145, a JSDK application 146, and a JSDK platform 147.

The standard applications 141 are a group of standard applications installed before shipment, which are for realizing the basic functions of the multifunction peripheral 101 such as a copying function, a printing function, a scanning function, and a facsimile function.

The CSDK application 145 and the JSDK application 146 are applications developed by using dedicated SDKs (software development kits). That is, it is possible to add new applications to the multifunction peripheral 101 after shipment by using the dedicated SDKs. The applications 131 developed by using SDKs are referred to as SDK applications in the present embodiment. As dedicated SDKs, there are provided a “CSDK” for developing an application 131 in the C language and a “JSDK” for developing an application 131 in the Java® language. An application 131 developed by the CSDK is referred to a “CSDK application” (CSDK application 145). An application 131 developed by the JSDK is referred to a “JSDK application” (JSDK application 146).

The JSDK platform 147 is a software component for providing an operating environment for the JSDK application 146 described in the Java® language. For example, the JSDK platform 147 includes a Java® virtual machine.

The SAS 142 is a software component for performing activation control, activation cancel control, install control, uninstall control, and update control of an SDK application. Conventionally, in Windows® applications, each application is accompanied by an installer. However, in the multifunction peripheral 101, the operations of installing and uninstalling all applications are performed by the SAS 142 in an integrated manner. As the applications are installed and uninstalled by the SAS 142 in an integrated manner, the user is not required to carry out different installing operations for each of the applications, i.e., the user's burden in carrying out installing operations is reduced.

The activation service 143 is software for determining whether to permit an SDK application to be activated under the control of the SAS 142. Details are described below. The activation service 143 determines whether to permit an SDK application to be activated based on data referred to as an activation key obtained via a network.

The install service 144 is software for executing a process to install an SDK application under the control of the SAS 142. The install service 144 determines the authenticity of an SDK application in the process of installation. An “authentic” application means that the SDK application is not falsified and is not used in a manner exceeding a permitted range (i.e., not used illegally).

The platforms 132 include a control service 151 and an OS 136.

The control service 151 is a group of software modules for providing services for controlling various hardware resources to upper level applications. For example, the control service 151 includes a network control service (NCS) 161 that is activated as a process for providing a service pertaining to network communication.

The OS 136 is a general OS such as UNIX®, and activates the above-described software in parallel with each other in units of processes.

In between the applications 131 and the platforms 132, a virtual application service (VAS) 135 is provided as software 112 for mediating the applications 131 and the platforms 132. The VAS 135 operates as a server process with the applications 131 acting as clients, and operates as a client process with the platforms 132 acting as servers. The VAS 135 has a wrapping function of hiding the platforms 132 from the applications 131, and has a role of absorbing the difference in versions caused by upgrading the platforms 132.

The multifunction peripheral activating unit 113 is executed first when the power of the multifunction peripheral 101 is turned on. Accordingly, the OS 136 such as UNIX® is activated, and the applications 131 and the platforms 132 are activated. These programs are loaded in a hard disk drive or a memory card, reproduced from the hard disk drive or the memory card, and activated in a memory.

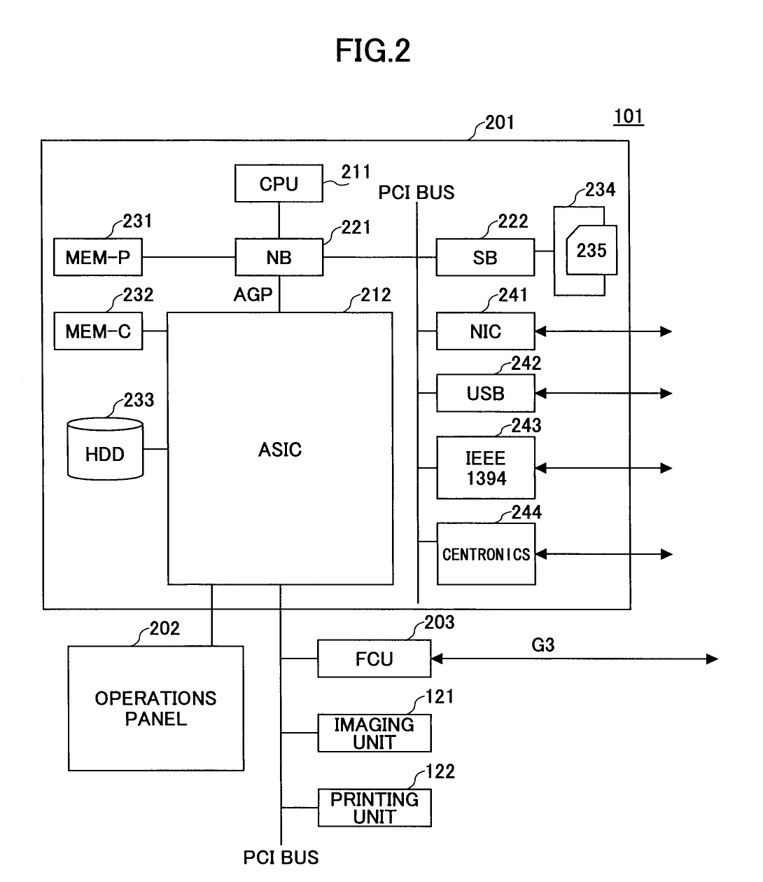

FIG. 2 is a hardware block diagram of the multifunction peripheral 101. The hardware 111 of the multifunction peripheral 101 includes a controller 201, an operations panel 202, a facsimile control unit (FCU) 203, the imaging unit 121, and the printing unit 122.

The controller 201 includes a CPU 211, an ASIC 212, an NB 221, an SB 222, an MEM-P 231, an MEM-C 232, an HDD (hard disk drive) 233, a memory card slot 234, NIC (network interface controller) 241, a USB device 242, an IEEE 1394 device 243, and a Centronics device 244.

The CPU 211 is an IC for performing various kinds of information processing. The ASIC 212 is an IC for performing various kinds of image processing. The NB 221 is a north bridge of the controller 201. The SB 222 is a south bridge of the controller 201. The MEM-P 231 is a system memory of the multifunction peripheral 101. The MEM-C 232 is a local memory of the multifunction peripheral 101. The HDD 233 is a storage of the multifunction peripheral 101. The memory card slot 234 is a slot for inserting a memory card 235, which is an example of a portable recording medium. The NIC 241 is a controller for performing network communications with MAC addresses. The USB device 242 is for providing a connection terminal of the USB specification. The IEEE 1394 device 243 is for providing a connection terminal of the IEEE 1394 specification. The Centronics device 244 is for providing a connection terminal of the Centronics specification.

The operations panel 202 is a hardware component for providing input into the multifunction peripheral 101 (operations unit) and also for obtaining output from the multifunction peripheral 101 (display unit).

(Multifunction Peripheral Activating Unit)

The following is a description of the multifunction peripheral activating unit 113 shown in FIG. 1.

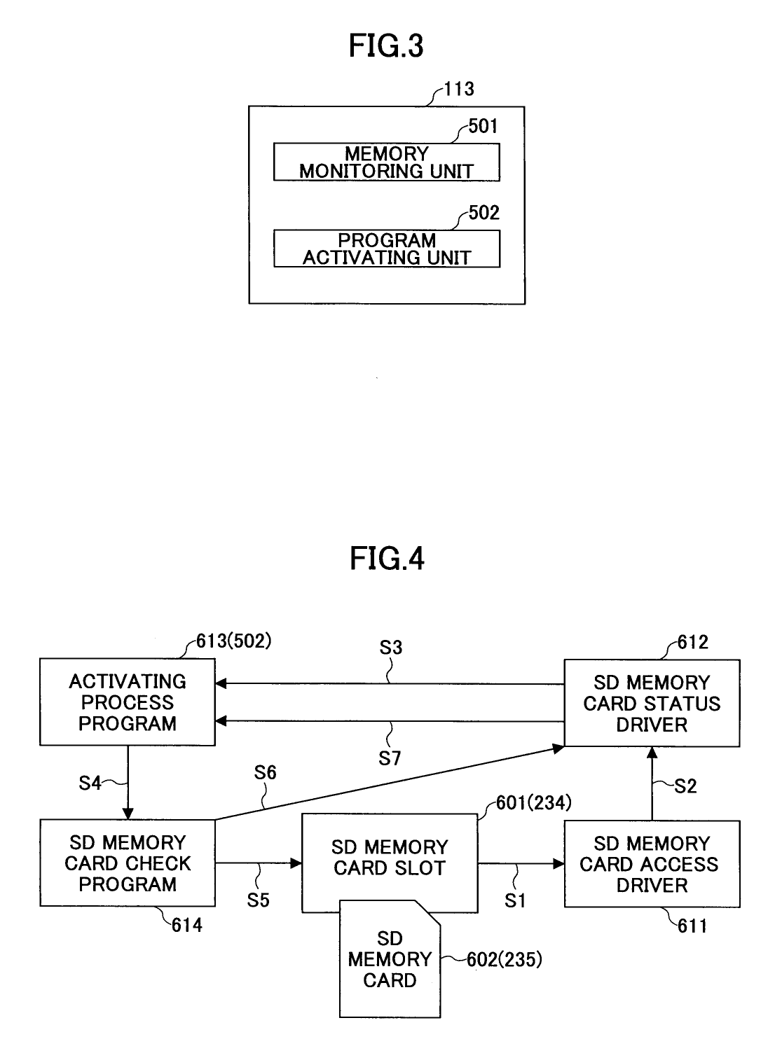

As shown in FIG. 3, the multifunction peripheral activating unit 113 includes a memory monitoring unit 501 and a program activating unit 502.

When the power of the multifunction peripheral 101 shown in FIG. 1 is turned on, a BIOS and a bootloader included in the memory monitoring unit 501 are activated. As a result, the OS 136 such as UNIX® is activated. Subsequently, a program for an activating process included in the program activating unit 502 is activated. As a result, the applications 131 and the platforms 132 are activated. When the UNIX® is activated, the kernel of UNIX® is activated, a root file system is deployed, and file systems pertaining to the applications 131 and the platforms 132 are mounted on the root file system.

(Memory Card)

The following is a description of the memory card slot 234 and the memory card 235 shown in FIG. 2.

The memory card slot 234 is for inserting the memory card 235 storing programs (computer programs) such as the applications 131 and the platforms 132. In the multifunction peripheral 101 shown in FIG. 1, the programs such as the applications 131 and the platforms 132 are loaded in the memory card 235 that is inserted in the memory card slot 234, reproduced from the memory card 235 inserted in the memory card slot 234, and activated in the MEM-P 231 and the MEM-C 232.

An SD (Secure Digital) memory card, which is a type of a flash memory card, can be employed as the memory card 235. By employing an SD memory card, a high capacity memory can be used at low cost. A slot for an SD memory card is employed as the memory card slot 234.

As shown in FIG. 4, the multifunction peripheral 101 includes software relevant to an SD memory card slot 601 and an SD memory card 602 (corresponding to the memory card slot 234 and the memory card 235), i.e., an SD memory card access driver (SDaccess) 611, an SD memory card status driver (SDstatus) 612, an activating process program 613, and an SD memory card check program (SDcheck) 614.

The SDaccess 611 is a driver for executing access control for the SD memory card 602, such as detecting that the SD memory card 602 has been inserted/ejected. The SDstatus 612 is a driver for managing information pertaining to inserting/ejecting/mounting/unmounting the SD memory card 602. The activating process program 613 is included in the program activating unit 502 shown in FIG. 3. The SDcheck 614 is a program for executing operations to mount/unmount the SD memory card 602.

When the SD memory card 602 is inserted to the SD memory card slot 601, the SDaccess 611 detects that the SD memory card 602 has been inserted (step S1), and reports this to the SDstatus 612 (step S2). In response, the SDstatus 612 manages information indicating that the SD memory card 602 has been inserted, and reports this to the activating process program 613 (step S3). In response, the activating process program 613 activates the SDcheck 614 to execute the mounting of the SD memory card 602 (step S4). In response, the SDcheck 614 executes the mounting of the SD memory card 602 (step S5), and reports this to the SDstatus 612 (step S6). In response, the SDstatus 612 manages information indicating that the SD memory card 602 has been mounted, and reports this to the activating process program 613 (step S7).

When the SD memory card 602 is ejected from the SD memory card slot 601, the SDaccess 611 detects that the SD memory card 602 has been ejected (step S1), and reports this to the SDstatus 612 (step S2). In response, the SDstatus 612 manages information indicating that the SD memory card 602 has been ejected, and reports this to the activating process program 613 (step S3). In response, the activating process program 613 activates the SDcheck 614 to execute the unmounting of the SD memory card 602 (step S4). In response, the SDcheck 614 executes the unmounting of the SD memory card 602 (step S5), and reports this to the SDstatus 612 (step S6). In response, the SDstatus 612 manages information indicating that the SD memory card 602 has been unmounted, and reports this to the activating process program 613 (step S7).

By employing the SD memory card, so-called hot plugging can be realized. An operation of inserting the SD memory card 602 in the SD memory card slot 601 and an operation of ejecting the SD memory card 602 from the SD memory card slot 601 can be executed after the multifunction peripheral 101 is activated.

(License Management)

The following is a description of license management of an application recorded in the SD memory card 602. In the present embodiment, as a matter of convenience, license management of the JSDK application 146 and the JSDK platform 147 is described. However, the mechanism of license management described in the present embodiment is not limited to these applications and is also effective for other applications such as the CSDK application 145.

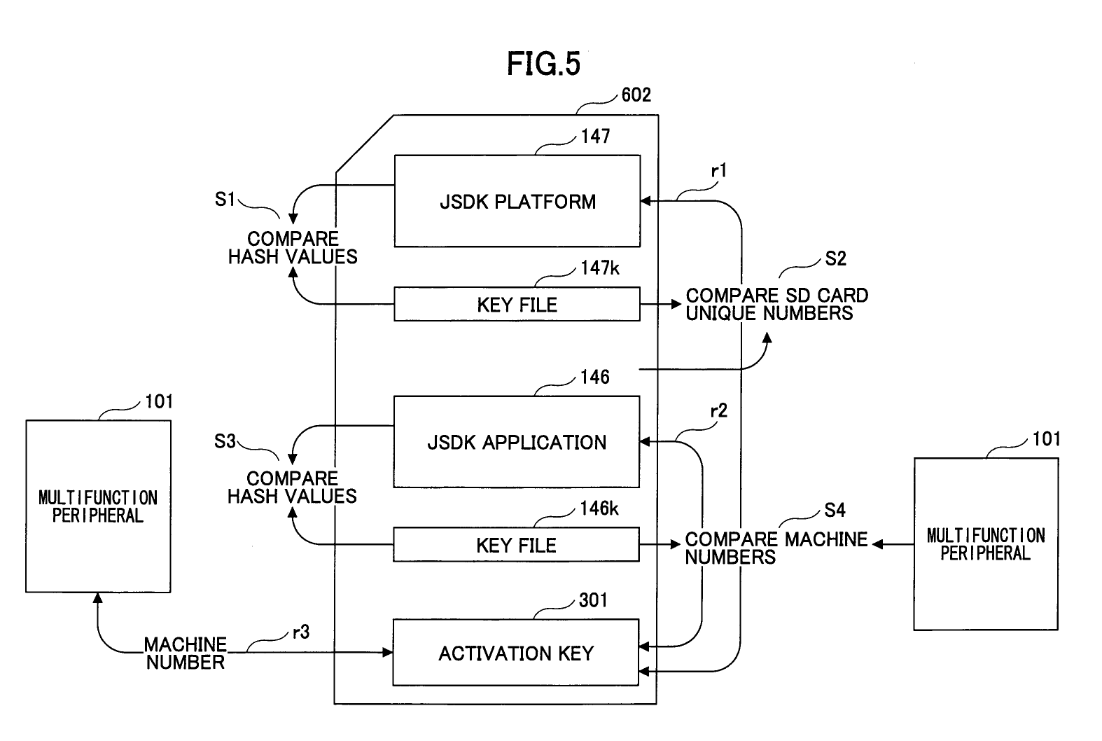

FIG. 5 illustrates an overview of license management of an application according to an embodiment of the present invention.

As shown in FIG. 5, in the present embodiment, when software (application) recorded in the SD memory card 602 is provided, a file called a key file is also recorded therein for each application in the SD memory card 602. The key file holds information necessary for detecting whether the application has been falsified or used illegally (i.e., has been illegally copied or is about to be used in an unauthorized multifunction peripheral). The structure of the loaded information can be the same for all of the applications or different for each application. In the present embodiment, the structure is different for each application.

In the present embodiment, the SD memory card 602 also stores the JSDK platform 147 and the JSDK application 146 that operates on the JSDK platform 147. A key file 147k corresponds to the JSDK platform 147, and holds in encrypted forms, a hash value of an execution code of the JSDK platform 147 and a number unique to the SD memory card 602 (hereinafter, “SD card number”). The SD card number is recorded in a predetermined region of the SD memory card 602 so as to be referred to. A key file 146k corresponds to the JSDK application 146, and holds in encrypted forms, a hash value of the execution code of the JSDK application 146 and the machine number of the multifunction peripheral 101 that is authorized to use the JSDK application 146. The machine number is unique to each multifunction peripheral 101, and is recorded in a predetermined recording medium of the multifunction peripheral 101 so as to be referred to.

It can be detected whether the JSDK platform 147 has been falsified by comparing the hash value (hereinafter, “hash value A”) loaded in the key file 147k with a hash value (hereinafter, “hash value B”) calculated from an execution code of the JSDK platform 147 (step S1). If the JSDK platform 147 has been falsified, the hash value A would not correspond to the hash value B, and therefore, it is possible to detect that the JSDK platform 147 has been falsified.

It can be detected whether the JSDK platform 147 has been copied by comparing the SD card number loaded in the key file 147k with the SD card number of the SD memory card 602 (step S2). If the JSDK platform 147 had been copied to another SD memory card together with the key file 147k, the SD card number of this other SD memory card would not correspond to the SD card number recorded in the key file 147k, and therefore, it is possible to detect whether the JSDK platform 147 has been copied.

When it is detected that the JSDK platform 147 has been copied or falsified during the process of installing or activating it, the process of installing or activating the JSDK platform 147 is cancelled. Therefore, it is possible to prevent installing or activating a JSDK platform 147 that has been copied or falsified.

Falsification of the JSDK application 146 can be detected by the same method as that for the JSDK platform 147. Specifically, the hash value loaded in the key file 146k is compared with a hash value calculated from an execution code of the JSDK application 146 (step S3).

It is detected whether the JSDK application 146 is being illegally used by comparing the machine number loaded in the key file 146k with the machine number of the multifunction peripheral 101 that is the target for installing or activating the JSDK application 146 (step S4). Specifically, if the SD memory card 602 is inserted in an unauthorized multifunction peripheral 101, the machine number acquired from the key file 146k would not correspond to the machine number of the target multifunction peripheral 101, and therefore, it is possible to detect illegal usage.

When it is detected that the JSDK application 146 has been falsified or is being illegally used during the process of installing or activating it, the process of installing or activating the JSDK application 146 is cancelled. Therefore, it is possible to prevent installing or activating a JSDK application 146 that has been falsified or is being illegally used.

The JSDK application 146 is not associated with an SD card number because the JSDK application 146 is operated on the JSDK platform 147, i.e., the JSDK application 146 is dependent on the JSDK platform 147. Specifically, in order to operate an illegal copy of the JSDK application 146, it is also necessary to create an illegal copy of the JSDK platform 147. Because the JSDK platform 147 is associated with an SD card number, if the JSDK platform 147 is copied to a different SD memory card 602, the JSDK platform 147 would not be permitted to be activated. Accordingly, the JSDK application 146 cannot be activated unless the JSDK platform 147 is activated. Thus, the JSDK application 146 is indirectly/practically prevented from being illegally copied. However, it is also possible to associate the JSDK application 146 with an SD card number, so that an illegal copy of the JSDK application 146 can be detected separately from the JSDK platform 147. In this case, an SD card number is also loaded in the key file 146k, and the SD card number loaded in the key file 146k is compared with the SD card number of the SD memory card 602 when installing or activating the JSDK application 146.

In the present embodiment, in order to realize a license management function for an application (the JSDK platform 147 and the JSDK application 146) via the network, an activation key 301 is used. The activation key 301 can be acquired by submitting a request together with a product ID of the application to be used and the machine number of a device (multifunction peripheral 101) in which the application is to be used. In FIG. 5, the activation key 301 is saved in the SD memory card 602; however, the activation key 301 does not necessarily need to be saved in the same SD memory card 602 as the application that is the target of license management. The activation key 301 is saved in different locations according to the operation method. For example, the activation key 301 can be saved in the multifunction peripheral 101 in which the target application is installed or executed, or the activation key 301 can be saved in a computer with which the multifunction peripheral 101 can communicate. The activation key 301 does not need to be recorded and provided together with the application in the SD memory card 602 when the application is initially provided. Actually, the activation key 301 can be provided after (or before) the application is installed. Furthermore, in FIG. 5, a single activation key 301 is used for both the JSDK platform 147 and the JSDK application 146; however, as in the case of the key file, separate activation keys 301 can be provided for each of the JSDK platform 147 and the JSDK application 146.

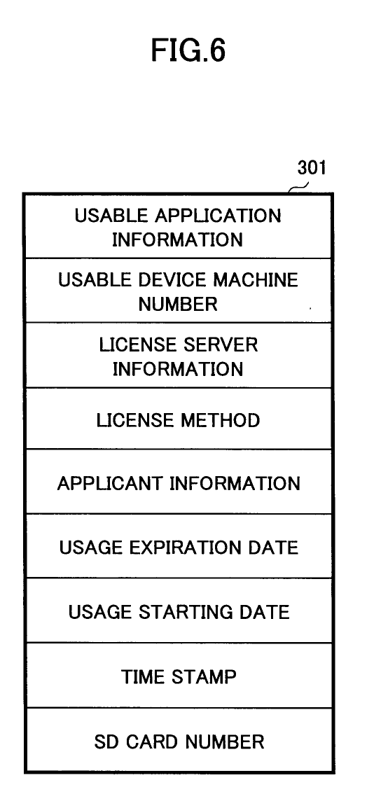

The activation key 301 is installed as a file for holding, e.g., the following information. FIG. 6 is an example of the structure of information held in the activation key 301. As shown in FIG. 6, the activation key 301 includes usable application information, a usable device machine number (of the multifunction peripheral 101), license server information, a license method, applicant information, a usage expiration date, a usage starting date, a time stamp, and an SD card number.

The usable application information is for identifying an application that can be used. For example, the product ID and the hash value of an application that can be used (is permitted to be used) with the activation key 301 correspond to the usable application information. The product ID is unique to each product name of software.

The usable device machine number is information for identifying the device (multifunction peripheral 101) in which the application is permitted to be installed or activated. For example, the machine number of the device or a hash value obtained from the hardware configuration of the device corresponds to the usable device machine number. In the present embodiment, the machine number is employed. When the application is permitted to be used in plural devices, plural machine numbers are loaded as the “usable device machine numbers”.

The license server information indicates address information of a license server. The license server corresponds to a computer that provides the activation key 301 for the multifunction peripheral 101. As described below, in the present embodiment, a key entry server or an activation management server corresponds to the license server, depending on the license method.

The license method is information for identifying the license method of each usable application. In the present embodiment, there are several license methods including an individual usage method, a node lock license method, and a floating license method, which are described in detail below.

Applicant information is for identifying the applicant who applied for the activation key 301. The applicant information may include a user name and a password used for changing specifications of the activation key 301.

The usage expiration date indicates the usage expiration date for each usable application.

The usage starting date indicates the date for starting to use the application for each usable application.

The time stamp is an electronic signature indicating the time at which the application for the activation key 301 is authenticated.

The SD card number is for the SD memory card 602, which number is used for associating the usable application with the SD memory card 602.

As is apparent from FIG. 6, the application whose license is managed with the activation key 301 is associated with the activation key 301 by a product ID and a hash value of the corresponding software (FIG. 5: r1, r2). The activation key 301 is associated with the multifunction peripheral 101 in which the software can be used, by a machine number (FIG. 5: r3).

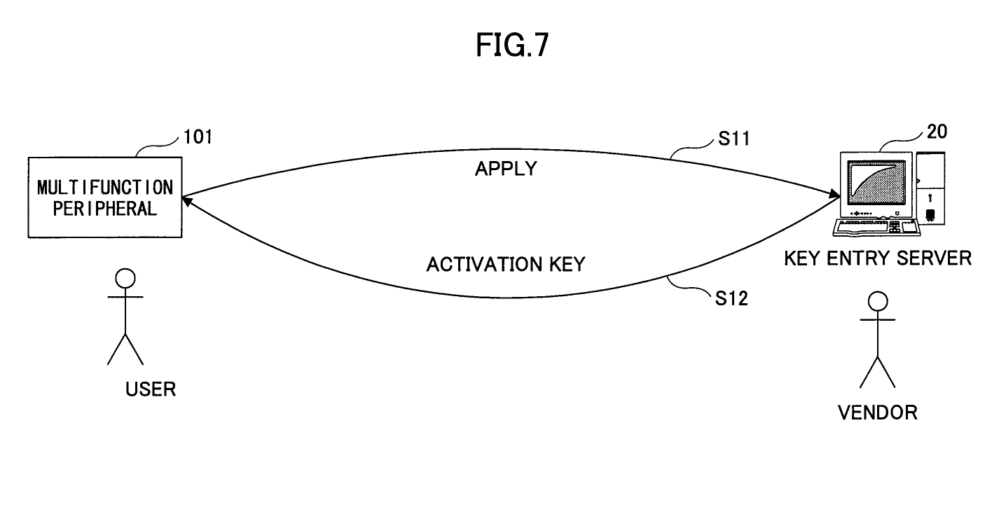

A method of performing license management using the activation key 301 is described in the following embodiments. FIG. 7 illustrates procedures of applying for and distributing (providing) an activation key according to a first embodiment of the present invention. In the first embodiment, a individual usage method is employed as the license method. The individual usage method is a license method that is appropriate for each user to individually acquire a license (activation key 301).

In FIG. 7, the multifunction peripheral 101 is a device for using an application recorded in the SD memory card 602. A key entry server 20 is a computer managed by the vendor of the application, and includes a function for generating the activation key 301.

When applying for the activation key 301, a user inputs an instruction to apply for (request) the activation key 301 from a request page displayed on the operations panel 202 of the multifunction peripheral 101. A request for the activation key 301 is submitted after the application recorded in the SD memory card 602 has been provided and the application has been installed in the multifunction peripheral 101 (or before being installed).

In response to the user's instruction, the multifunction peripheral 101 sends request information (information for applying for the activation key 301) to the key entry server 20 (step S11). The multifunction peripheral 101 can automatically send request information as the SD memory card 602 is inserted in the SD memory card slot 601. The request information includes, for example, the product ID of the usable application, the machine number of the multifunction peripheral 101, a license method, applicant information, a usage expiration date for the application, a usage starting date for the application, a time stamp, and an SD card number. However, if the application is not to be associated with the SD memory card 602, the SD card number is unnecessary. Items included in the request information can be input by the user or can be acquired or determined by the multifunction peripheral 101 from the inserted SD memory card 602 or from within the multifunction peripheral 101.

When the request information is received, the key entry server 20 generates the activation key 301 based on the request information, and sends the activation key 301 to the multifunction peripheral 101 that is the request source (step S12). In generating the activation key 301, the product ID of the usable application, the machine number of the usable device (multifunction peripheral 101), the license method, the applicant information, the usage expiration date, the usage starting date, and the SD card number are copied from the request information. The hash value of the application in the usable application information is generated in the key entry server 20 based on an execution code of the application. It is assumed that the key entry server 20 is managed by the vendor of the application and can thus obtain the execution code of the application. However, a hash value can be generated in the multifunction peripheral 101 and can be included in the request information. Address information of the key entry server 20 is used as the license server information. The time stamp is acquired by the key entry server 20 from a predetermined time stamp service.

When the activation key 301 is received, the multifunction peripheral 101 saves (registers) it in a location (for example, the HDD 233 or the SD memory card 602 where the application is recorded) of the multifunction peripheral 101 where it can be referred to when installing or activating the application.

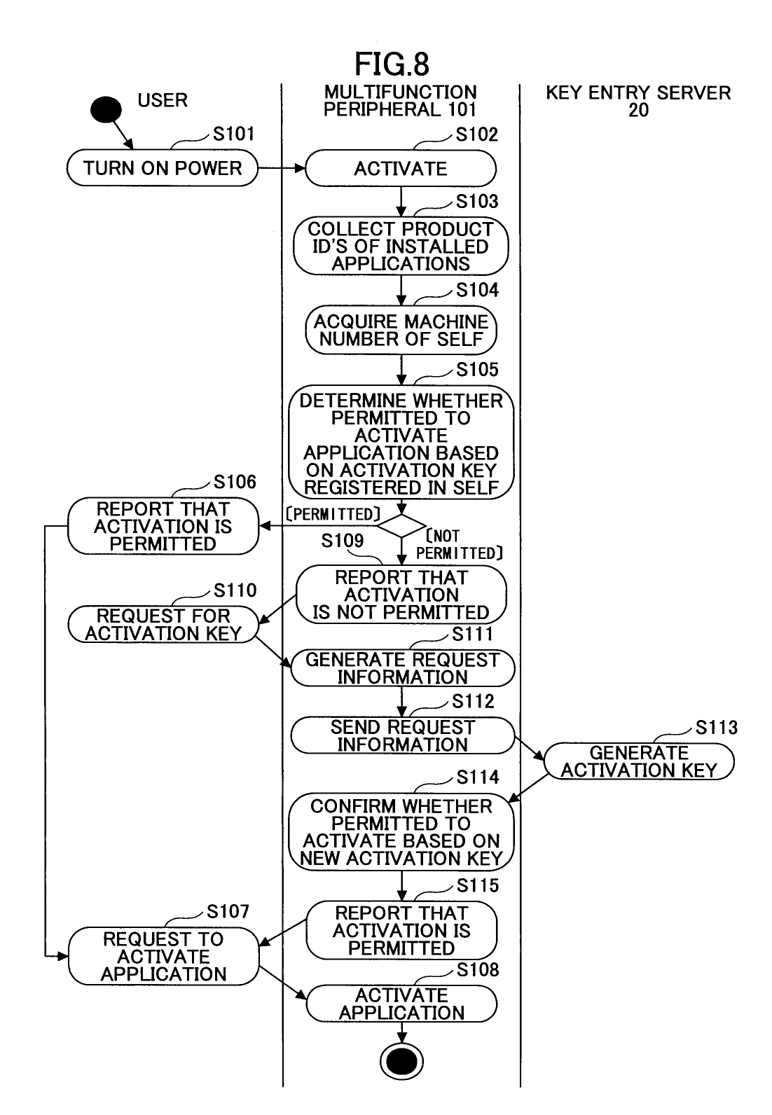

FIG. 8 illustrates a process of activating an application using the activation key according to the first embodiment of the present invention. The following process is executed by the activation service 143 of the multifunction peripheral 101.

When a user turns on the power of the multifunction peripheral 101 (step S101), the multifunction peripheral 101 is activated (step S102). The multifunction peripheral 101 collects product IDs of applications installed in itself such as the JSDK platform 147 and the JSDK application 146 (step S103), and acquires the machine number of itself (step S104). For each application, the multifunction peripheral 101 determines whether it has a license for using the application (whether it is permitted to activate the application) based on the activation key 301 registered in itself (step S105). Specifically, the multifunction peripheral 101 is permitted to activate a target application if the following conditions are satisfied; that is, there is an activation key 301, the machine number of the multifunction peripheral 101 itself is included among the usable device machine numbers in the activation key 301, a product ID of the target application is included among the usable application information in the activation key 301, a hash value of the target application corresponds to the hash value included in the usable application information in the activation key 301, and the present time is within a period defined by the usage starting date and the usage expiration date in the activation key 301.

If the multifunction peripheral 101 is permitted to activate an application, the multifunction peripheral 101 displays a message to this effect on the operations panel 202 (step S106). For example, the multifunction peripheral 101 displays a button for activating the application on the operations panel 202 to indicate that the application can be activated. When an instruction to activate the application is received from the user (step S107), the multifunction peripheral 101 activates the application (step S108).

On the other hand, if the multifunction peripheral 101 is not permitted to activate an application, the multifunction peripheral 101 reports to the user of such an application via the operations panel 202, and prompts the user to apply for the activation key 301 (step S109). The multifunction peripheral 101 can automatically display a request page. When the user inputs to the request page an instruction to apply for the activation key 301 (step S110), the multifunction peripheral 101 generates request information (step S111), and sends the request information to the key entry server 20 (step S112). When the request information is received, the key entry server 20 generates the activation key 301 based on the request information, and sends it to the multifunction peripheral 101 that is the request source (step S113). Details of the processes of steps S110-S113 are the same as the processes described with reference to FIG. 7.

Based on the new activation key 301 received, the multifunction peripheral 101 confirms whether it has a license for using the application (whether it is permitted to activate the application) as in step S105 (step S114). If activation of the application is permitted, the multifunction peripheral 101 reports to the user that activation of the application is permitted (step S115). When an instruction to activate the application is received from the user (step S107), the multifunction peripheral 101 activates the application (step S108).

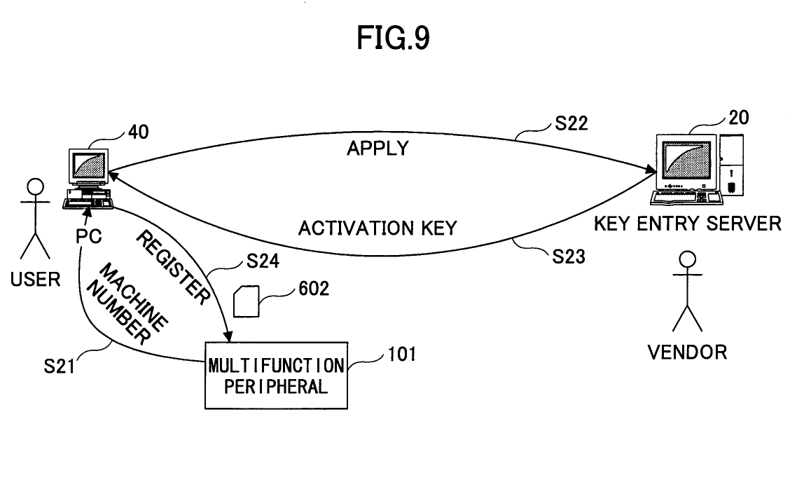

Next, a description is given of a second embodiment of the present invention. The individual usage method is employed as the license method also in the second embodiment. However, the difference between the first embodiment is that a request for the activation key 301 is not made from the multifunction peripheral 101 but from a PC (personal computer) of the user. FIG. 9 illustrates procedures of applying for (requesting) and distributing (providing) an activation key according to the second embodiment of the present invention. In FIG. 9, elements corresponding to those in FIG. 7 are denoted by the same reference numbers, and are not further described. In FIG. 9, a PC 40 is used by the user to submit a request for the activation key 301.

To apply for the activation key 301, the user inputs request information from a Web page displayed on the PC 40. The PC 40 sends the request information to the key entry server 20 (step S22). However, if the PC 40 and the multifunction peripheral 101 are connected on-line, the PC 40 can automatically acquire the machine number, etc., of the multifunction peripheral 101 via a network (step S21) and send the request information to the key entry server 20 based on the acquired information.

When the request information is received, the key entry server 20 generates the activation key 301 based on the request information, and sends the activation key 301 to the PC 40 that is the request source (step S23). The activation key 301 is generated by the same method as that of the first embodiment.

If the PC 40 and the multifunction peripheral 101 are connected on-line, the PC 40 automatically registers the received activation key 301 in the multifunction peripheral 101 via the network (step S24). If the PC 40 and the multifunction peripheral 101 are off-line, the SD memory card 602 with the application recorded therein is to be inserted in the PC 40. In this case, the PC 40 writes the received activation key 301 in the SD memory card 602. Thus, the SD memory card 602 would be in the status shown in FIG. 5. The user inputs the SD memory card 602 in the multifunction peripheral 101, and registers the activation key 301.

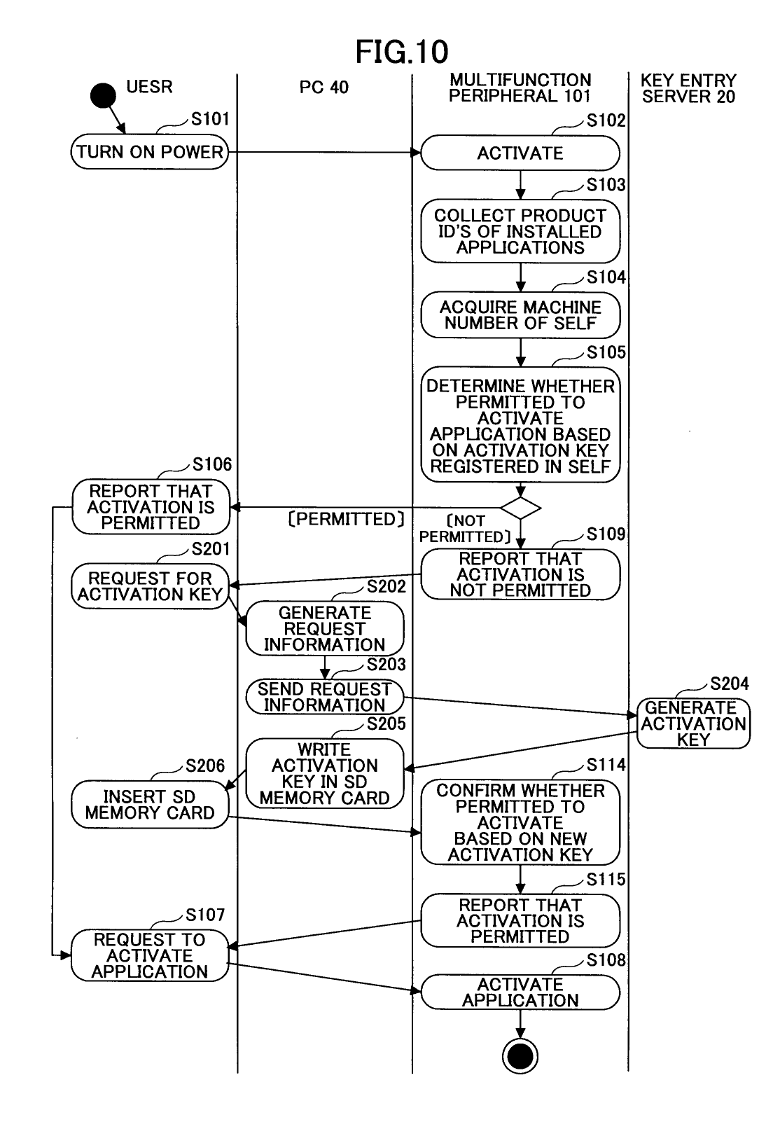

FIG. 10 illustrates a process of activating an application using the activation key according to the second embodiment of the present invention. The following process is executed by the activation service 143 of the multifunction peripheral 101. In FIG. 10, steps corresponding to those in FIG. 8 are denoted by the same reference numbers, and are not further described.

In the second embodiment, the procedure (steps S201-S206) of applying for an activation key 301 for an application that the multifunction peripheral 101 is not permitted to activate is different from that of the first embodiment. That is, when the multifunction peripheral 101 reports to a user of the application that the multifunction peripheral 101 is not permitted to activate the application, the user uses the PC 40 to apply for the activation key 301 (step S201). The PC 40 generates request information based on input from the user (step S202) and sends the request information to the key entry server 20 (step S203). When the request information is received, the key entry server 20 generates the activation key 301 based on the request information and sends the activation key 301 to the PC 40 that is the request source (step S204). When the activation key 301 is received, the PC 40 writes the activation key 301 in the SD memory card 602 (step S205). When the user inserts the SD memory card 602 in the SD memory card slot 601 of the multifunction peripheral 101, based on the new activation key 301 recorded in the SD memory card 602, the multifunction peripheral 101 confirms whether it has a license for using the application (whether it is permitted to activate the application) as in step S105 (step S114). If activation of the application is permitted, the multifunction peripheral 101 reports to the user that activation of the application is permitted (step S115). When an instruction to activate the application is received from a user (step S107), the multifunction peripheral 101 activates the application (step S108).

For a user such as a company that uses plural multifunction peripherals 101, it would be convenient to be able to apply for the activation keys 301 for plural multifunction peripherals 101 all at once. A description is given of a third embodiment of the present invention in which it is possible to apply for the activation keys 301 for plural multifunction peripherals 101 all at once. In the third embodiment, there are two types of license methods. One method is the node lock license method and the other is the floating license method. In the node lock license method, the machine numbers for all multifunction peripherals 101 to be used are submitted and license management is performed according to each machine. In the floating license method, license management is performed based on the number of machines used at the same time, and the license management is performed in the same manner for plural multifunction peripherals 101. It is possible to employ different license methods according to the type of application, such as employing the node lock license method for the JSDK platform 147 and employing the floating license method for the JSDK application 146.

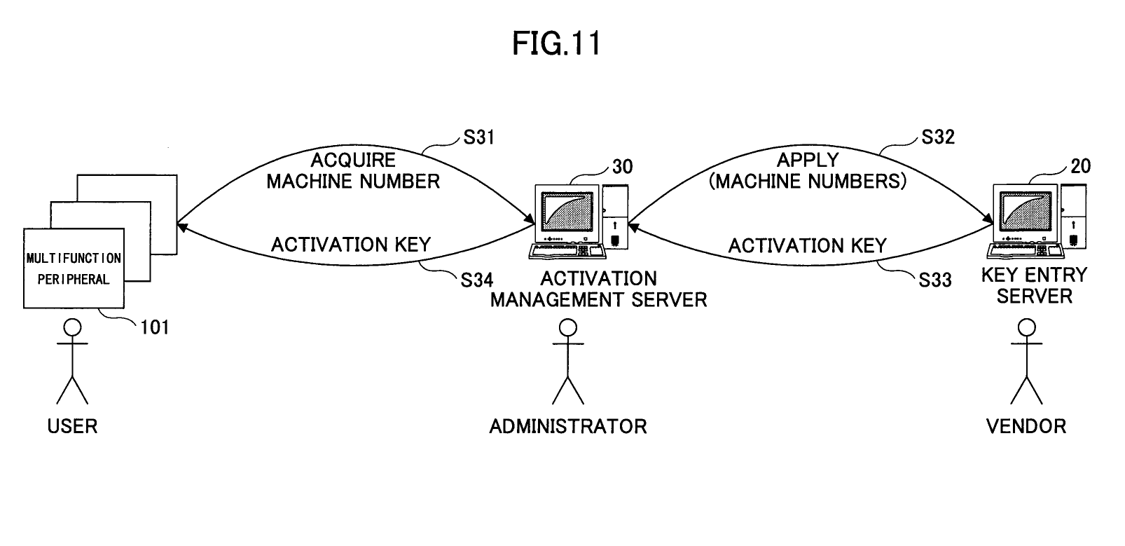

FIG. 11 illustrates procedures of applying for and distributing (providing) an activation key by the node lock license method according to the third embodiment of the present invention. In FIG. 11, elements corresponding to those in FIG. 7 or 9 are denoted by the same reference numbers, and are not further described. In FIG. 11, an activation management server 30 belongs to the user of the multifunction peripheral 101 and manages licenses of plural multifunction peripherals 101. In the third embodiment, the activation management server 30 manages licenses of plural multifunction peripherals 101 regardless of whether the node lock license method or the floating license method is employed.

In response to an instruction from an administrator, the activation management server 30 acquires machine numbers of plural multifunction peripherals 101 for which activation keys 301 are requested (step S31). The activation management server 30 generates request information including plural machine numbers and the product ID of the application to be used, and sends the request information to the key entry server 20 (step S32). Accordingly, applications are made all at once for the activation keys 301 for plural multifunction peripherals 101.

When the request information is received, the key entry server 20 generates the activation key 301 corresponding to plural machine numbers based on the request information, and sends the activation key 301 to the activation management server 30 (step S33). At this point, the activation key 301 corresponding to plural machine numbers means that the field of “usable device machine number” in the activation key 301 includes plural machine numbers. Based on the received activation key 301, the activation management server 30 generates separate activation keys 301 corresponding to each machine number, and sends each activation key 301 to the corresponding multifunction peripheral 101 (step S34). Accordingly, one activation key 301 is registered in each multifunction peripheral 101. At this point, one activation key 301 corresponding to each machine number means that the field of “usable device machine number” in the activation key 301 includes only one machine number.

Accordingly, in the node lock license method, the activation management server 30 performs essential functions in the procedure of distributing (registering) the activation keys 301 to the multifunction peripherals 101.

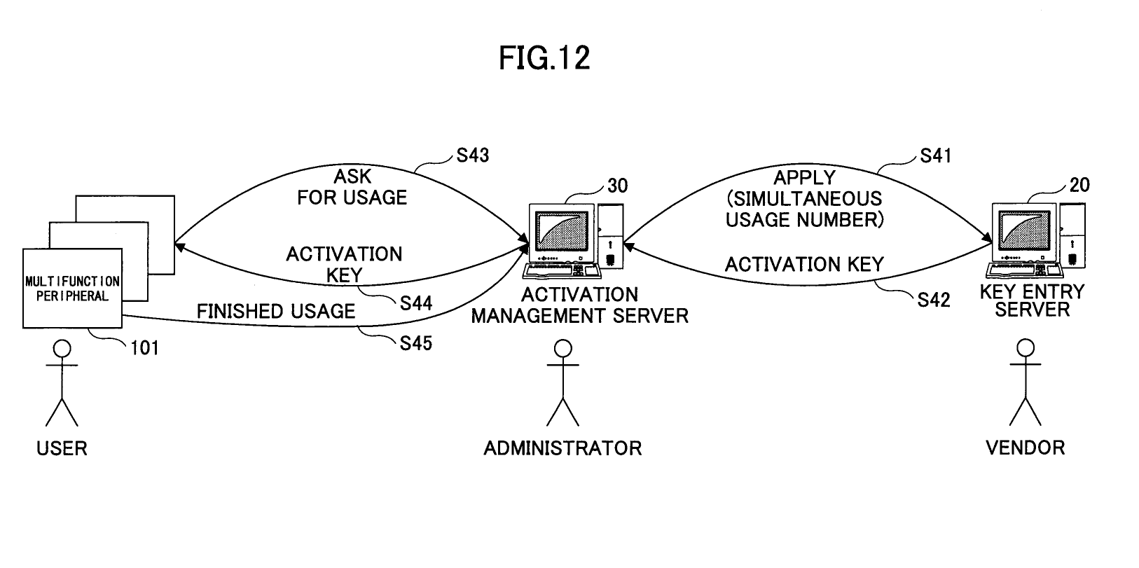

FIG. 12 illustrates procedures of applying for and distributing (providing) an activation key by the floating license method according to the third embodiment of the present invention. In FIG. 12, elements corresponding to those in FIG. 11 are denoted by the same reference numbers, and are not further described.

In response to an instruction from an administrator, the activation management server 30 sends request information to the key entry server 20 (step S41). The request information does not include machine numbers of plural multifunction peripherals 101; instead, the request information includes a maximum number of devices (multifunction peripherals 101) that can be used at the same time (maximum simultaneous usage number).

When the request information is received, the key entry server 20 generates an activation key 301 defining the maximum simultaneous usage number based on the request information, and sends the activation key 301 to the activation management server 30 (step S42). The activation key 301 defining the maximum simultaneous usage number means that the activation key 301 includes the maximum simultaneous usage number instead of the “usable device machine number”.

When an instruction to use an application is given by a user, the multifunction peripheral 101 sends a request to the activation management server 30 to provide the activation key 301 (step S43). This request is sent together with the machine number of the multifunction peripheral 101 and the product ID of the application. The activation management server 30 determines whether the number of devices currently being used at the same time (simultaneous usage number) has reached the maximum simultaneous usage number. If not, the activation management server 30 generates the activation key 301 corresponding to the machine number and the product number (i.e., the activation key 301 including the product ID as the usable application information and the machine number of the multifunction peripheral 101 as the usable device machine number), and sends the activation key 301 to the multifunction peripheral 101 (step S44). In this case, the simultaneous usage number managed in the memory of the activation management server 30 is incremented. If the simultaneous usage number has reached the maximum simultaneous usage number, the activation management server 30 does not send back the activation key 301.

When the activation key 301 is received, the multifunction peripheral 101 determines whether usage of the application is permitted based on the activation key 301. If usage is permitted, the user can use the application. When the user finishes using the application, the multifunction peripheral 101 reports to the activation management server 30 that the user has finished using the application (usage end report) (step S45). When the usage end report is received, the activation management server 30 renews (decrements) the simultaneous usage number. When the activation key 301 is not received, the multifunction peripheral 101 does not permit the usage of the application.

In this manner, in the floating license method, the multifunction peripheral 101 performs essential functions for asking the activation management server 30 whether usage of an application is permitted. Furthermore, the multifunction peripherals 101 that are permitted to use the application are not limited to specific multifunction peripherals 101.

Next, a description is given of a process of installing and activating an application by a license method using the activation management server 30.

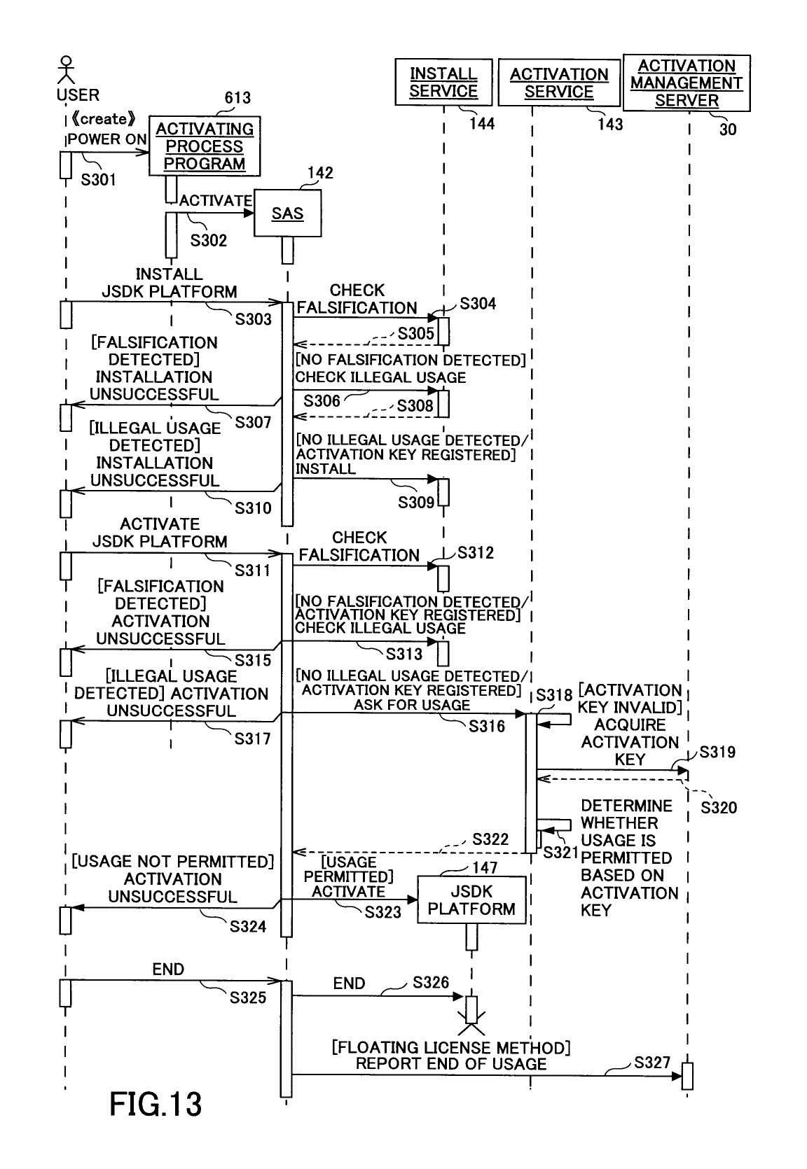

FIG. 13 is a sequence diagram of a process of installing and activating the JSDK platform 147 according to the third embodiment of the present invention.

When a user turns on the power switch of the multifunction peripheral 101, the activating process program 613 that manages the activating procedure of the system of the multifunction peripheral 101 is activated (step S301). Then, the activating process program 613 activates the SAS 142 (step S302). The SAS 142 is loaded inside the multifunction peripheral 101 before shipment, and therefore, it is not checked whether the SAS 142 has been falsified.

The user inserts, into the SD memory card slot 601, the SD memory card 602 storing at least the JSDK platform 147 and the key file 147k. The SAS 142 displays an operations page on the operations panel 202. The user inputs an instruction from the operations page to install the JSDK platform 147 (step S303). Before installing the JSDK platform 147, the SAS 142 checks the JSDK platform 147 as to whether it has been falsified and to prevent illegal usage. Specifically, the SAS 142 sends a request to the install service 144 to check whether the JSDK platform 147 has been falsified (step S304). The install service 144 checks whether the JSDK platform 147 has been falsified, and sends the check results to the SAS 142 (step S305). The install service 144 checks whether the JSDK platform 147 has been falsified by comparing a hash value of the JSDK platform 147 and a hash value loaded in the key file 147k. The install service 144 determines that the JSDK platform 147 has not been falsified if the hash values are the same and determines that the JSDK platform 147 has been falsified if the hash values are not the same.

If the JSDK platform 147 has not been falsified, the SAS 142 sends a request to the install service 144 to check whether the JSDK platform 147 is being illegally used (step S306). The install service 144 checks whether the JSDK platform 147 is being illegally used by comparing an SD card number of the SD memory card 602 and an SD card number loaded in the key file 147k. The install service 144 determines that the JSDK platform 147 is not being illegally used if the SD card numbers are the same and determines that JSDK platform 147 is being illegally used if the SD card numbers are not the same. The determination results are sent to the SAS 142 (step S308).

If the JSDK platform 147 is not being illegally used or the activation key 301 is registered, the SAS 142 instructs the install service 144 to install the JSDK platform 147 (step S309). The install service 144 installs the JSDK platform 147 recorded in the SD memory card 602 into the multifunction peripheral 101.

If it is detected that the JSDK platform 147 has been falsified or is being illegally used, and the activation key 301 is not registered, the SAS 142 cancels the installation of the JSDK platform 147 and causes the operations panel 202 to display an error page (step S307 or S310).

When the installation is normally completed and the user inputs an instruction to activate the JSDK platform 147 from the operations page displayed on the operations panel 202 by the SAS 142 (step S311), the SAS 142 sends a request to the install service 144 to check whether the JSDK platform 147 has been falsified (step S312). The process performed for checking falsification is the same as that performed at the time of installation. If falsification is not detected or if the activation key 301 is registered in the multifunction peripheral 101, the SAS 142 sends a request to the install service 144 to check whether the JSDK platform 147 is being illegally used (step S313). If the JSDK platform 147 is not being illegally used or if the activation key 301 is registered in the multifunction peripheral 101, the SAS 142 sends a request to the activation service 143, asking to use the JSDK platform 147 (step S316).

If falsification is detected and the activation key 301 is not registered, or illegal usage is detected and the activation key 301 is not registered, the SAS 142 cancels the activation of the JSDK platform 147 and causes the operations panel 202 to display an error page (step S315 or S317).

When a request to use the JSDK platform 147 is received, the activation service 143 determines whether the activation key 301 is valid (step S318). The validity of the activation key 301 corresponds to whether the activation key 301 itself is authentic, i.e., whether it is proper to use the activation key 301 for determining whether the JSDK platform 147 is permitted to be used. For example, it is determined whether the activation key 301 is registered in the multifunction peripheral 101 or whether the activation key 301 has not been falsified, etc. By attaching an electronic signature of the activation key 301 to the activation key 301, it can be detected whether the activation key 301 has been falsified based on the electronic signature.

If the activation key 301 is invalid (including cases where the activation key 301 is not registered), the activation service 143 sends a request to the activation management server 30 to provide another activation key 301 (step S319). This request is sent together with the machine number of the multifunction peripheral 101 and the product ID of the application. In the node lock license method, if the activation management server 30 is holding the activation key 301 corresponding to the machine number and the product ID, the activation management server 30 sends the activation key 301 to the activation service 143 (step S320). In the floating license method, if the simultaneous usage number has not reached the maximum simultaneous usage number, the activation management server 30 sends the activation key 301 to the activation service 143, and increments the simultaneous usage number (step S320). Subsequently, the activation service 143 determines whether usage of the JSDK platform 147 is permitted based on the activation key 301 (step S321), and sends the determination results to the SAS 142 (step S322). Details of the process of determining whether usage is permitted based on the activation key 301 are described below.

If usage is permitted, the SAS 142 activates the JSDK platform 147 (step S323). If usage is not permitted, the SAS 142 cancels the activation and causes the operations panel 202 to display an error page (step S324).

When the user inputs an instruction to end the JSDK platform 147 via the operations page caused to be displayed by the SAS 142 (step S325), the SAS 142 ends the JSDK platform 147 (step S326). In the case of the floating license method, the SAS 142 reports to the activation management server 30 that usage of the JSDK platform 147 has ended (step S327). Then, the activation management server 30 decrements the simultaneous usage number.

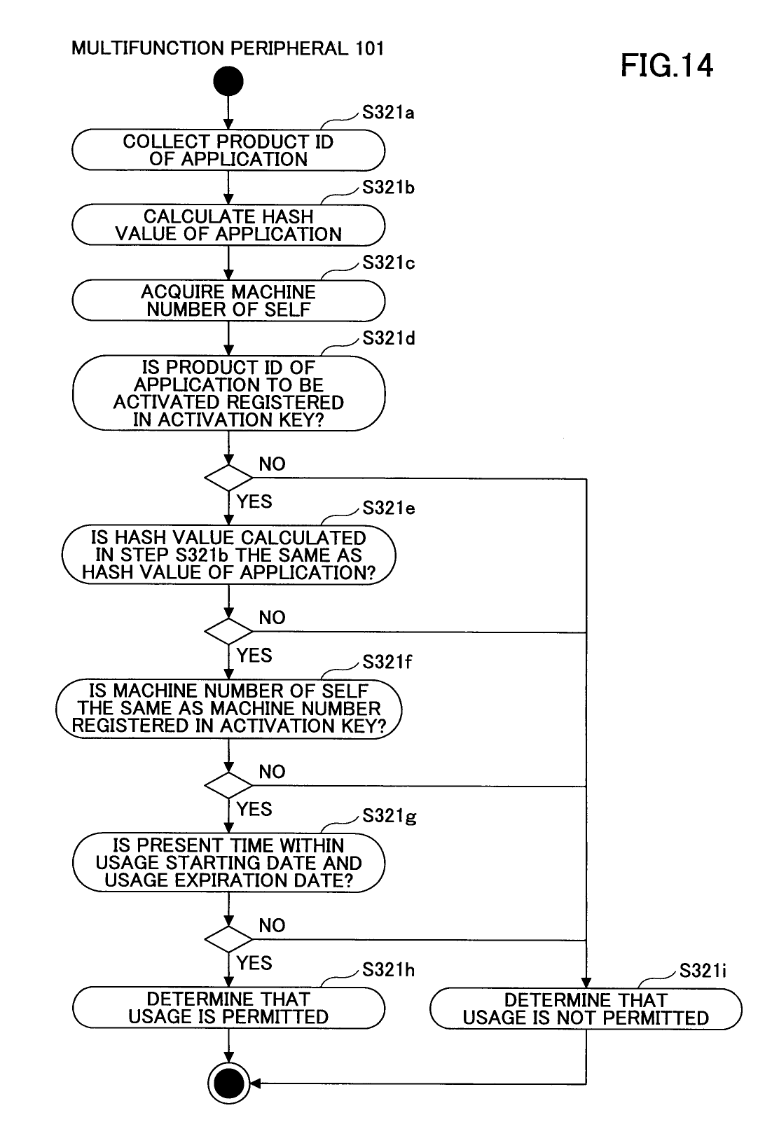

Next, a description is given of a process performed in step S321 to determine, based on the activation key 301, whether usage of an application (in FIG. 13, the JSDK platform 147) is permitted. FIG. 14 is a flowchart of the process of determining whether usage of an application is permitted based on the activation key.

First, the product ID of the application, which is the activation target, is collected (step S321a). A hash value of the application is calculated (step S321b). The machine number of the multifunction peripheral 101 is acquired (step S321c). The activation service 143 determines whether the collected product ID is included in the usable application information in the activation key 301 (step S321d). If the determination result is affirmative, the activation service 143 determines whether the hash value calculated in step S321b and the hash value included in the usable application information in the activation key 301 are the same (step S321e). If the determination result is affirmative, the activation service 143 determines whether the machine number acquired from the multifunction peripheral 101 and the usable device machine number in the activation key 301 are the same (step S321f). If the determination result is affirmative, the activation service 143 determines whether the present time is within a period defined by the usage starting date and the usage expiration date in the activation key 301 (step S321g). If the determination result is affirmative, the activation service 143 determines that usage of the application is permitted (step S321h). If any of the determination results in steps S321d-321g is negative, the activation service 143 determines that usage of the application is not permitted (step S321i).

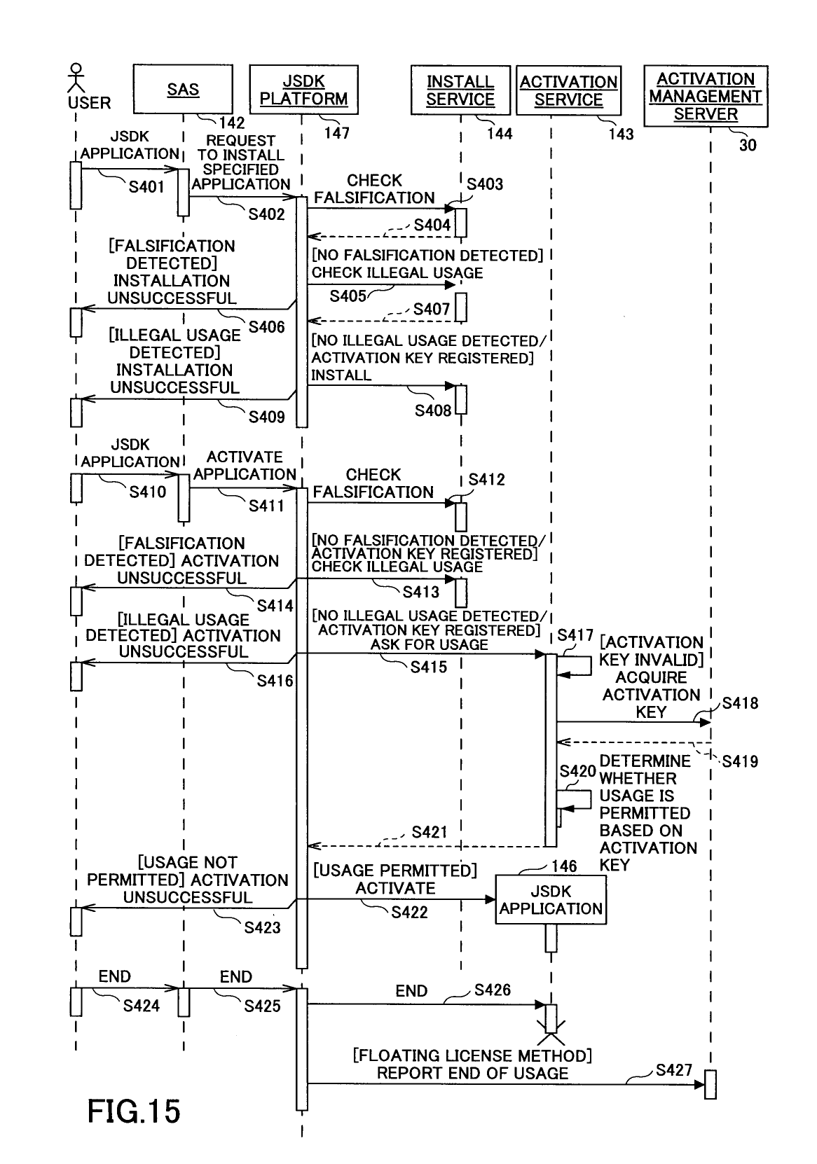

Next, a description is given of a process of installing and activating the JSDK application 146. FIG. 15 is a sequence diagram of a process of installing and activating the JSDK application 146 according to the third embodiment of the present invention.

The user inserts, into the SD memory card slot 601, the SD memory card 602 storing at least the JSDK application 146 and the key file 146k. The SAS 142 displays an operations page on the operations panel 202. The user inputs an instruction from the operations page to install the JSDK application 146 (step S401). The SAS 142 instructs the JSDK platform 147 to install the JSDK application 146 (step S402).

Before installing the JSDK application 146, the JSDK platform 147 checks the JSDK application 146 as to whether it has been falsified and to prevent illegal usage. Specifically, the JSDK platform 147 sends a request to the install service 144 to check whether the JSDK application 146 has been falsified (step S403). The install service 144 checks whether the JSDK application 146 has been falsified, and sends the check results to the JSDK platform 147 (step S404). The install service 144 checks whether the JSDK application 146 has been falsified by comparing a hash value of the JSDK application 146 and a hash value loaded in the key file 146k. The install service 144 determines that the JSDK application 146 has not been falsified if the hash values are the same and determines that the JSDK application 146 has been falsified if the hash values are not the same.

If the JSDK application 146 has not been falsified, the JSDK platform 147 sends a request to the install service 144 to check whether the JSDK application 146 is being illegally used (step S405). The install service 144 checks whether the JSDK application 146 is being illegally used by comparing a machine number of the multifunction peripheral 101 and a machine number loaded in the key file 146k. The install service 144 determines that the JSDK application 146 is not being illegally used if the machine numbers are the same and determines that JSDK application 146 is being illegally used if the machine numbers are not the same. The determination results are sent to the JSDK platform 147 (step S407).

If the JSDK application 146 is not being illegally used or the activation key 301 is registered, the JSDK platform 147 instructs the install service 144 to install the JSDK application 146 (step S408). The install service 144 installs the JSDK application 146 recorded in the SD memory card 602 into the multifunction peripheral 101.

When it is detected that the JSDK application 146 has been falsified or is being illegally used, and the activation key 301 is not registered, the JSDK platform 147 cancels the installation of the JSDK application 146 and causes the operations panel 202 to display an error page (step S406 or S409).

When the installation is normally completed and the user inputs an instruction to activate the JSDK application 146 from the operations page displayed on the operations panel 202 by the SAS 142 (step S410), the SAS 142 requests the JSDK platform 147 to activate the JSDK application 146 (step S411). The JSDK platform 147 sends a request to the install service 144 to check whether the JSDK application 146 has been falsified (step S412). The process performed for checking falsification is the same as that performed at the time of installation. If falsification is not detected or if the activation key 301 is registered in the multifunction peripheral 101, the JSDK platform 147 sends a request to the install service 144 to check whether the JSDK application 146 is being illegally used (step S413). If the JSDK application 146 is not being illegally used or if the activation key 301 is registered in the multifunction peripheral 101, the JSDK platform 147 sends a request to the activation service 143, asking to use the JSDK application 146 (step S415).

If falsification is detected and the activation key 301 is not registered, or illegal usage is detected and the activation key 301 is not registered, the JSDK platform 147 cancels the activation of the JSDK application 146 and causes the operations panel 202 to display an error page (step S414 or S416).

When a request to use the JSDK application 146 is received, the activation service 143 determines whether the activation key 301 is valid (step S417). If the activation key 301 is invalid (including cases where the activation key 301 is not registered), the activation service 143 sends a request to the activation management server 30 to provide another activation key 301 (step S418). This request is sent together with the machine number of the multifunction peripheral 101 and the product ID of the JSDK application 146. In the node lock license method, if the activation management server 30 is holding the activation key 301 corresponding to the machine number and the product ID, the activation management server 30 sends the activation key 301 to the activation service 143 (step S419). In the floating license method, if the simultaneous usage number has not reached the maximum simultaneous usage number, the activation management server 30 sends the activation key 301 to the activation service 143, and increments the simultaneous usage number (step S419). Subsequently, the activation service 143 determines whether usage of the JSDK application 146 is permitted based on the activation key 301 (step S420), and sends the determination results to the JSDK platform 147 (step S421). Details of the process of determining whether usage is permitted based on the activation key 301 are as described with reference to FIG. 14.

If usage is permitted, the JSDK platform 147 activates the JSDK application 146 (step S422). If usage is not permitted, the JSDK platform 147 cancels the activation and causes the operations panel 202 to display an error page (step S423).

When the user inputs an instruction to end the JSDK application 146 via the operations page caused to be displayed by the SAS 142 (step S424), in response to the instruction received from the SAS 142 (step S425), the JSDK platform 147 ends the JSDK application 146 (step S426). In the case of the floating license method, the JSDK platform 147 reports to the activation management server 30 that usage of the JSDK application 146 has ended (step S427). Then, the activation management server 30 decrements the simultaneous usage number.

As described above, the multifunction peripheral 101 according to the first-third embodiments manages a license of an application based on information such as the activation key 301 that can be obtained via a network even after the application has been installed. Accordingly, license management can be performed more flexibly compared to the case where license management is performed based on information such as the key file that is provided together with the application (hereinafter, “local license management”). To cite an example of flexibility, even if an application recorded in the SD memory card 602 is associated with a specific SD memory card 602 (SD card number) or a specific multifunction peripheral 101 (machine number) by a key file recorded in the SD memory card 602, a user without any illegal intentions does not have to purchase another SD memory card 602. Specifically, with the multifunction peripheral 101 according to an embodiment of the present invention, when such a user desires to use the application in another environment (another SD memory card 602 or another multifunction peripheral 101), the user can submit a request to obtain an activation key 301 corresponding to the desired environment (by performing a simple operation via a network). The request is submitted together with information pertaining to the application to be used and the desired environment (desired SD memory card 602 or desired multifunction peripheral 101). Thus, the user can use the application in another SD memory card 602 or another multifunction peripheral 101 without purchasing a new SD memory card 602 (without obtaining a new physical medium).

This is possible because the activation key 301 is given priority over the key file. More specifically, with reference to the above embodiments, even if the authenticity of an application is determined as negative based on a key file, if there is an activation key 301 and the activation key 301 is valid, it is determined whether it is permitted to use the application based on the activation key 301 (for example, steps S313-S321 shown in FIG. 13 and steps S413-S420 shown in FIG. 15).

Furthermore, in the license management method according to an embodiment of the present invention, it is not required to change existing components (key file, etc.) in the SD memory card 602 used as a medium for distributing (providing) an application. Therefore, it is possible to maintain compatibility with a local license management method where key files are used. That is, the license management according to an embodiment of the present invention can also be performed for an application recorded in an SD memory card 602 that is managed based on a conventional license management method.

The vendor of an application can charge fees for distributing (providing) the activation key 301 so as to prevent losses in sales profits. A mechanism for charging fees can be realized by using conventional techniques, and is thus not further described herein.

In the above described embodiments, the activation key 301 is associated with an application and a device. The activation key 301 can also be associated with a user. For example, applicant information (see FIG. 6) of the activation key 301 can be used as identification information (user ID, etc.) of the user who is permitted to use the application with the activation key 301. That is, the applicant information to be included in the request information when applying for the activation key 301 does not necessarily correspond to the user who is making the request but corresponds to ID information of one or more users who are to use the application. In this case, the activation service 143 executes the following process instead of those shown in FIG. 8 or 10.

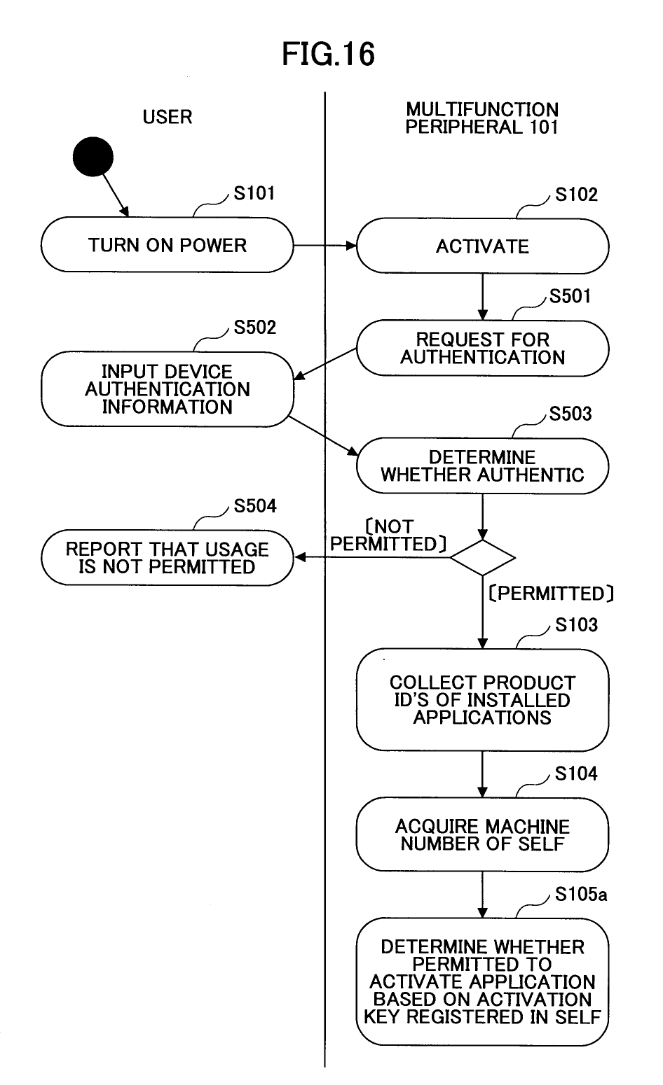

FIG. 16 illustrates a process of activating an application using the activation key associated with a user. In FIG. 16, steps corresponding to those in FIG. 8 are denoted by the same reference numbers, and are not further described.

When the multifunction peripheral 101 is activated, the multifunction peripheral 101 requests a user to input authentication information (for authenticating the user) (step S501). Specifically, for example, the multifunction peripheral 101 displays a message on the operations panel 202 prompting the user to input authentication information. When the user inputs authentication information (step S502), the multifunction peripheral 101 authenticates the user based on the authentication information (step S503).

The authentication information is not limited to a specific format; the authentication information can be, for example, a user name, a password, information recorded in an IC card or a magnetic card, or biometric data (fingerprint data). A user name or a password can be input via the operations panel 202. Information recorded in an IC card or a magnetic card or biometric data (fingerprint data) can be read by a dedicated reading unit connected to the multifunction peripheral 101 via a USB cable or a network. Such a dedicated reading unit can also be connected to a PC that is connected to the multifunction peripheral 101. In any case, user information including authentication information is registered for each user in the multifunction peripheral 101. User authentication is performed by comparing input information with authentication information included in the user information. If the authentication is successful (i.e., the user is authenticated), identification information of the user (user ID, etc.) included in the user information is specified.

This authentication process can also be performed by a computer (authentication server) connected to the multifunction peripheral 101 via a network. In this case, the multifunction peripheral 101 transfers the input authentication information to the authentication server. In the authentication server, user information for each user is registered, and user authentication is performed by comparing the authentication information included in the user information and the authentication information received from the multifunction peripheral 101. The authentication results (if the authentication is successful, the identification information of the authenticated user is also included in the results) are sent to the multifunction peripheral 101.

When the user is determined not to be authentic, the multifunction peripheral 101 displays a message to this effect on the operations panel 202, and rejects activation of the application (step S504). When the user is determined to be authentic, the multifunction peripheral 101 collects product IDs of applications installed in itself (step S103), and acquires the machine number of itself (step S104). For each application, the multifunction peripheral 101 determines whether it has a license for the application (whether it is permitted to activate the application) based on the activation key 301 registered in itself (step S105a). In this example, the following conditions must be satisfied to permit the application to be activated. The conditions are that there is an activation key 301, the machine number of the multifunction peripheral 101 itself is included among the usable device machine numbers in the activation key 301, the product ID of the application is included among the usable application information in the activation key 301, the hash value of the application corresponds to the hash value included in the usable application information in the activation key 301, the present time is within a period defined by the usage starting date and the usage expiration date in the activation key 301, and identification information of the user specified as a result of the authentication is included in the applicant information in the activation key 301. The authentication information can be used as the identification information of the user. In this case, the applicant information in the activation key 301 is to include authentication information of one or more users who are permitted to user the application.

The processes from and beyond step S106 are the same as those shown in FIG. 8 or 10, and are thus not further described.

In the above embodiments, the activation key 301 and a device (multifunction peripheral 101) that is permitted to use an application based on the activation key 301 are associated with each other by a machine number. That is, a device that is permitted to use an application is identified by the “usable device machine number” included in the activation key 301.

However, this does not mean that the information associating the activation key 301 with the device (hereinafter, “device associating information”) is limited only to the machine number. Any information can be used as the device associating information instead of the machine number as long as it uniquely identifies each device (information unique to each device).

For example, instead of the machine number per se (the number not processed or converted), it is possible to use a hash value or an encrypted value of the machine number as the device associating information. Other examples of device associating information are information unique to each component of the device (e.g., a unique ID of the HDD, a MAC (Media Access Control) address of an Ethernet card of the device, a unique ID of the motherboard of the device, a unique ID of the USB device of the device, a unique ID of the RAM of the device, or unique information of software installed in the device (e.g., a hash value)), a hash value or an encrypted value of each of the aforementioned information items, or a hash value or an encrypted value of an arbitrary combination of the machine number and the aforementioned information items. A combination of information included in the activation key 301 and the aforementioned information items or a hash value or an encrypted value of such a combination can also be used.

In this case (i.e., when device associating information other than the machine number per se is used), the request information used to apply for the activation key 301 is to include information necessary for such device associating information. The key entry server 20 or the activation management server 30 that generates the activation key 301 is to generate the activation key 301 by including the device associating information instead of the “usable device machine number” (see FIG. 6). The activation service 143 that determines whether an application can be activated based on the activation key 301 is to acquire information including the device associating information from the corresponding device, generate a hash value or an encrypted value from the acquired information according to need, and compare it with the device associating information included in the activation key 301. As the device associating information is included in the activation key 301, the association between the activation key 301 and the device associating information is realized.

It is also possible to associate the activation key 301 with a device by encrypting the activation key 301 using any of the device associating information items (including the machine number per se) as a cryptographic key.

In this case (when the device associating information is used as a cryptographic key to encrypt the activation key 301), the request information used to apply for the activation key 301 is to include information necessary for the device associating information. The key entry server 20 or the activation management server 30 that generates the activation key 301 is to encrypt the activation key 301 with the use of the device associating information. The activation service 143 that determines whether an application is permitted to be activated based on the activation key 301 is to confirm the association between the activation key 301 and the device by decrypting the activation key 301 with the use of the device associating information. If the activation key 301 can be decrypted with the use of the device associating information, it is confirmed that the activation key 301 is a license for the corresponding device. If the activation key 301 cannot be decrypted with the use of the device associating information, it is confirmed that the activation key 301 is not a license for the corresponding device. In this method, the device associating information does not have to be included in the activation key 301 because the association between the activation key 301 and the device associating information is realized by encrypting the activation key 301 with the use of the device associating information.

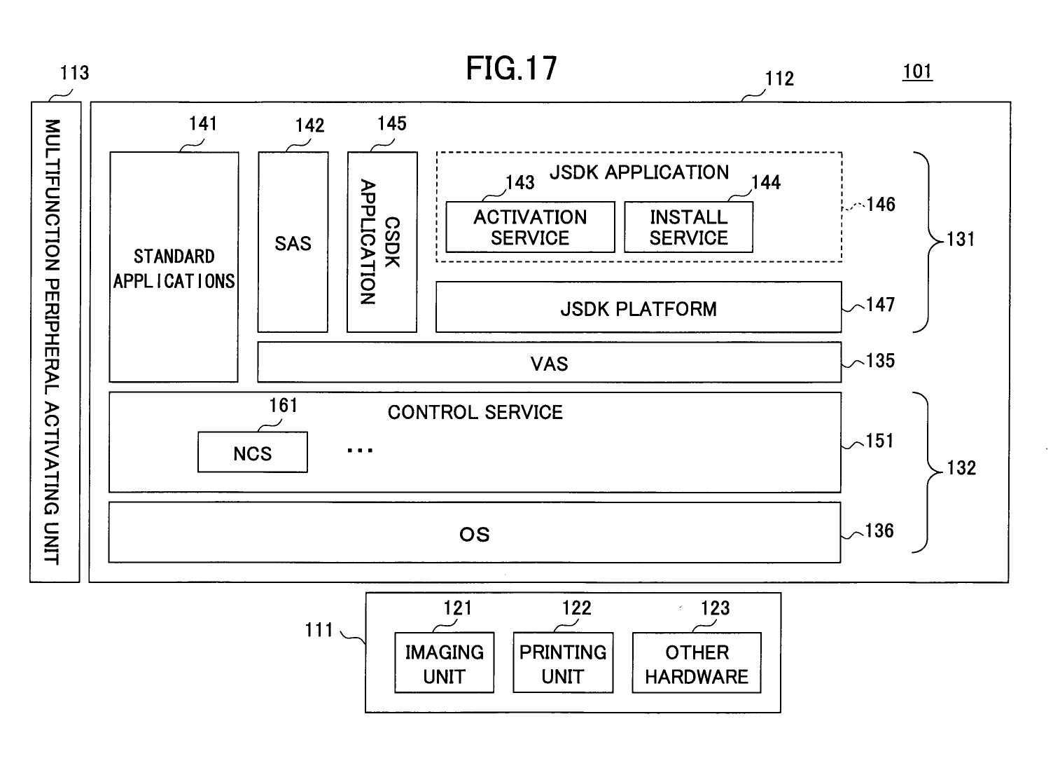

Incidentally, the activation service 143 and the install service 144 can be implemented as the JSDK application 146. FIG. 17 is a block diagram of a software configuration of the multifunction peripheral 101, in which the activation service 143 and the install service 144 are implemented as the JSDK application 146.

In FIG. 17, the activation service 143 and the install service 144 are included inside the block of the JSDK application 146. This means that the activation service 143 and the install service 144 are implemented as the JSDK application 146. Even if the activation service 143 and the install service 144 are implemented as the JSDK application 146, the above-described processes are unaffected.

The present invention is not limited to the specifically disclosed embodiment, and variations and modifications may be made without departing from the scope of the present invention.

The present application is based on Japanese Priority Patent Application No. 2006-158704, filed on Jun. 7, 2006 and Japanese Priority Patent Application No. 2007-143645, filed on May 30, 2007, the entire contents of which are hereby incorporated by reference.

What is claimed is:

1. An image forming apparatus to which a program can be additionally provided, the image forming apparatus comprising:
an activation determining unit configured to receive, via a communication network, usage permission data that is associated with program identification information unique to each program and device identification information unique to each image forming apparatus, wherein:
said activation determining unit determines whether a target program is permitted to be activated by respectively comparing the program identification information and the device identification information associated with the usage permission data with program identification information of the target program and device identification information of the image forming apparatus in which the activation determining unit is included.

2. The image forming apparatus according to claim 1, wherein:
the usage permission data comprises the device identification information.

3. The image forming apparatus according to claim 1, wherein:
the usage permission data comprises a hash value of the device identification information or an encrypted value of the device identification information.

4. The image forming apparatus according to claim 1, wherein:
the device identification information comprises information unique to a component of the image forming apparatus.

5. The image forming apparatus according to claim 1, wherein:
the usage permission data is encrypted with the use of the device identification information.

6. The image forming apparatus according to claim 1, wherein:
the usage permission data comprises user identification information; and
the activation determining unit determines whether the target program is permitted to be activated by comparing user identification information of a user requesting to activate the target program and the user identification information included in the usage permission data.

7. The image forming apparatus according to claim 1, wherein:
the target program is recorded in a portable target recording medium; and
the portable target recording medium comprises authentication determination data comprising at least one of the device identification information unique to each image forming apparatus and medium identification information unique to each recording medium, and a hash value unique to each program, wherein the image forming apparatus further comprises:
an authentication determining unit configured to determine whether the target program is authentic by comparing at least one of the device identification information of the image forming apparatus in which the authentication determining unit is included and medium identification information of the portable target recording medium with the device identification information and/or the medium identification information included in the authentication determination data, and also by comparing a hash value of the target program with the hash value included in the authentication determination data.

8. The image forming apparatus according to claim 7, wherein:
even when the authentication determining unit determines that the target program is not authentic, the target program is activated if the activation determining unit determines that the target program is permitted to be activated.

9. A license management method executed by an image forming apparatus to which a program can be additionally provided, the license management method comprising the steps of:
receiving, via a communication network, usage permission data that is associated with program identification information unique to each program and device identification information unique to each image forming apparatus; and
determining whether a target program is permitted to be activated by respectively comparing the program identification information and the device identification information associated with the usage permission data with program identification information of the target program and device identification information of the image forming apparatus executing the license management method.

10. The license management method according to claim 9, wherein:
the usage permission data comprises the device identification information.

11. The license management method according to claim 9, wherein:
the usage permission data comprises a hash value of the device identification information or an encrypted value of the device identification information.

12. The license management method according to claim 9, wherein:
the device identification information comprises information unique to a component of the image forming apparatus.

13. The license management method according to claim 9, wherein:
the usage permission data is encrypted with the use of the device identification information.

14. The license management method according to claim 9, wherein:
the usage permission data comprises user identification information; and
the determining step comprises the step of determining whether the target program is permitted to be activated by comparing user identification information of a user requesting to activate the target program and the user identification information included in the usage permission data.

15. The license management method according to claim 9, wherein:
the target program is recorded in a portable target recording medium; and
the portable target recording medium comprises authentication determination data comprising at least one of the device identification information unique to each image forming apparatus and medium identification information unique to each recording medium, and a hash value unique to each program; wherein the license management method further comprises the step of:
determining whether the target program is authentic by comparing at least one of the device identification information of the image forming apparatus executing the license management method and medium identification information of the portable target recording medium with the device identification information and/or the medium identification information included in the authentication determination data, and also by comparing a hash value of the target program with the hash value included in the authentication determination data.

16. The license management method according to claim 15, wherein:
even when it is determined that the target program is not authentic, the target program is activated if it is determined that the target program is permitted to be activated.

17. A license management program product comprising instructions for causing a computer to perform the steps of the license management method according to claim 9.
